(19) United States
(12) Patent Application Publication
(10) Pub. No.: US 2005/0147722 A1
(43) Pub. Date: Jul. 7, 2005

(54) Integrated process for separation of oil, protein, carbohydrates, shell and minor toxic components from seeds

(76) Inventors: Gao Wen Fan, Chengdu City (CN); David Sue San Ho, Ipoh (MY)

Correspondence Address: MEYER UNKOVIC & SCOTT LLP, 1300 OLIVER BUILDING, PITTSBURGH, PA, 15222, US

(21) Appl. No.: 10/799,161

(22) Filed: Mar. 12, 2004

(30) Foreign Application Priority Data
Mar. 12, 2003 (MY) PI 20030847

(51) Int. Cl. A23J 1/14

(52) U.S. Cl. 426/482

(57) ABSTRACT

This invention relates to a method for the separation of oil, protein, carbohydrates, shell, and minor toxic components from seeds. The oil seed is subjected to a dehulling process to separate out the hull and kernel and the dehulled oil seed is then compressed into flakes under low temperature. The oil seed is then dephenolized and undergo low temperature delintion. In addition, direct hydrolyzation of the oil-complex is carried out. This technology can be used to produce high quality oil and obtain hydrolyzed protein, thereby comprehensively utilizing the oil seed.

### CROSS-REFERENCE TO RELATED APPLICATION

This patent claims priority from the patent application of the same name filed in Malaysia on Mar. 12, 2003 and assigned Malaysian patent application number PI 20030847.

### TECHNICAL FIELD OF THE INVENTION

This invention relates to the separation of components of cottonseeds, rubber seeds, and other seeds into oil, protein, carbohydrates, shell, and toxic components.

### BACKGROUND OF THE INVENTION

The separation of oils and fats from vegetable materials constitutes a distinct and specialized branch of fat technology. Most of the extraction processes have common objectives: (i) to obtain the oil uninjured and as free as possible from undesirable impurities; (ii) to obtain the oil in as high a yield as is consistent with the economy of the process; and (iii) to produce residue or co-product of the greatest value.

In the case of seeds or other materials initially high in oil and low in solids content, the unextracted residue will contain only a small fraction of the total oil; however, in seeds of low solid content, such as soybeans, it may contain as much as fifteen to twenty (15-20%) percent of the total oil. In processing of cottonseed, special attention had to be given to the inactivation of gossypol or other toxic constituents.

Historically, the extraction of cottonseed oil has not been able to achieve the best yield that is consistent with the economy of the process. For example, the average yield of oil from the commercial processing of cottonseed by solvent extraction and using undecorticated seeds is eighteen (18%) percent. Cottonseed oil extracted by conventional technology is brownish yellow and contains the toxic substance gossypol. Hence, it is not popular to consumers. Cottonseed residue (pulp) is used as feedstuff for oxen and sheep or used as fertilizer.

A need exists for a new effective method, process, and apparatus for: (i) extracting gossypol from cottonseed kernel; (ii) converting wastes into valuables; and (iii) extracting innoxious high-grade cotton oil, protein, and oligosaccharides. The present invention satisfies that need. Additionally, one embodiment of the present invention does not involve discharge of wastewater and offscum. Therefore, the present invention overcomes the problem of environmental pollution, which occurs in the conventional processes.

In the preferred embodiment of the present invention, cottonseed is discussed, but other suitable seeds such as sunflower seed, safflower, peanut, flax seed, hemp seed, rape seed, poppy seed, rubber seed, and the like can be used.

### SUMMARY OF THE INVENTION

It is, therefore, an object of one embodiment of the present invention to provide a process for the separation of oil, protein, carbohydrates, shell, and minor toxic components from seeds.

It is yet another object of one embodiment of the present invention to provide for a seed oil obtained by the method according to the present invention.

It is a further object of one embodiment of the present invention to provide for an apparatus to produce seed oil according to the method of the present invention.

Accordingly, in the preferred embodiment of the present invention, there is provided a process for the separation of oil, protein, carbohydrates, shell, and minor toxic components from oil seed, wherein said process comprises the steps of:
a. dehulling of oil seed to separate the shell and kernel;
b. compressing the kernel obtained in (a) into flakes at room temperature;
c. agitating and mixing the flakes obtained in (b) with a mixture of dephenolizers comprising alcohol, acid, and an enzyme, for a period of time at a specific temperature;
d. mixing the filtrate obtained in (c) with a complexing compound to form a gossypol complex;
e. hydrolyzing, crystallizing, filtering, and washing the gossypol complex to yield industrial gossypol;
f. treating the dephenolized flakes obtained in (c) with liquid propane and butane to yield oil, for a period of time at a specific temperature;
g. dissolving pulp derived from oil extraction in an alkali environment to yield protein upon precipitation; and
h. adding saturated limewater to the protein waste solution obtained in (g), followed by precipitation, filtration of residual gossypol, electrolysis, and condensation to yield carbohydrates.

More specifically, in a preferred embodiment of the present invention, the process of separating gossypol includes the decorticated and dehulling of delintioned cottonseed to separate the cottonseed shells and kernels. The cottonseed kernel obtained will be compressed into flakes whereby the shells go through a dephenolization process to form colorings, such as melanin.

More specifically, the compressed flakes are agitated and mixed with the dephenolizers. This mixture is then leached for a known period of time and transferred to a complexing tank. Aniline is added to form aniline-gossypol complex, which goes through hydrolyzation, crystallization, filtration, and lastly washing to yield industrial gossypol.

The dephenolized cottonseed kernels are immersed with a mixture of propane and butane to extract the oil. The oil is recycled through decompression, aeration, and evaporation to form clear cotton oil. The residue (pulp) from which oil has been extracted is dissolved via an alkaline treatment before being purified through centrifugation. The pH of the supernatant is then adjusted with acid to a lower pH and further centrifuged. In the preferred embodiment of this invention, the pH should be in a range of about 3.8-5.8. The protein precipitation is bleached and spray-dried to obtain cotton protein powder.

The protein waste solution is then combined with saturated limewater, precipitated, filtered of residual gossypol, processed via electrodialysis, and condensed to form paste-like cottonseed sugar.

Another embodiment of the present invention comprises an apparatus for performing the above-identified steps. A further embodiment of the present invention also includes the means of hydrolyzation of the crude protein and the addition of an enzyme compound to acquire hydrolyzed protein. Yet another embodiment of the present invention comprises a seed oil produced according to the above-identified steps.

The present invention has many advantages. In a preferred embodiment, it is an integrated process to separate oil, protein, carbohydrates, shell, and minor toxic components from cottonseed. Although cottonseed is preferred, it will be obvious to one skilled in the art that many other suitable oil seeds can be used and the use of them is covered by this invention.

### BRIEF DESCRIPTION OF THE FIGURES

For the present invention to be easily understood and readily practiced, the invention will now be described, for purposes of illustration and not limitation, in connection with the following figures, wherein:

FIG. 1 is a flow chart showing one embodiment of the process of separation of oil, protein, carbohydrates, shell, and minor toxic components from oil seed;

FIG. 2 is a schematic diagram showing one embodiment of an alkali refining and oligosaccharide plant of the present invention; and

FIG. 3 is a schematic diagram showing one embodiment of an integrated process of separation of oil, protein, shell, and minor toxic components from oil seed according to one embodiment of the present invention.

### DETAILED DESCRIPTION OF THE INVENTION

The present invention, either as steps of the invention or as combinations of parts of the invention, will now be more particularly described. It will be understood that the particular embodiments of this invention are shown by way of illustrations and not as limitations to the invention. The principal features of the invention may be employed in various embodiments without departing from the scope of the invention.

The preferred embodiment of the present invention utilizes cottonseed. Therefore, the characteristics and history of cottonseed are disclosed. It will be obvious to those skilled in the art that this invention may be used with a variety of other seeds, but modifications will have to be made to certain of the steps and parameters of this invention to accommodate the differing characteristics of each type of seed.

Cottonseed kernels contain twenty-six (26%) percent oil and more than thirty-six (36%) percent protein. Principally, fatty acid in cotton oil contains oleic acid, linoleic acid, and other unsaturated fatty acids, as well as being rich in nutritional ingredients such as —OH containing compounds. It has high physiological value. Cottonseed residue (pulp) after defatting is as high as forty-five (45%) percent or more, with its main amino acid composition being better than soybean protein. Cottonseed kernel is also rich in cottonseed sugar and other oligosaccharides.

Even though gossypol is a toxic substance, it is also an important raw material for the chemical industry.

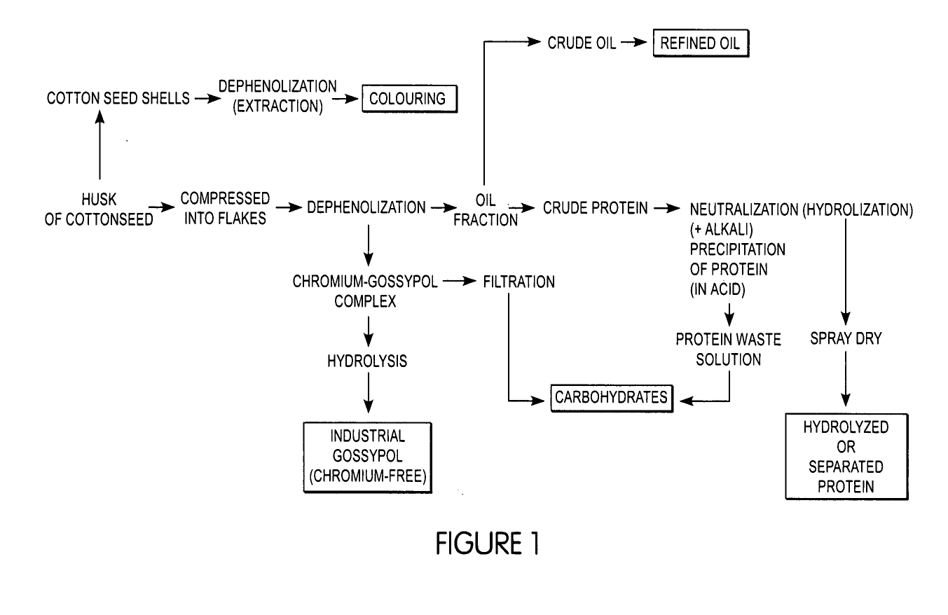

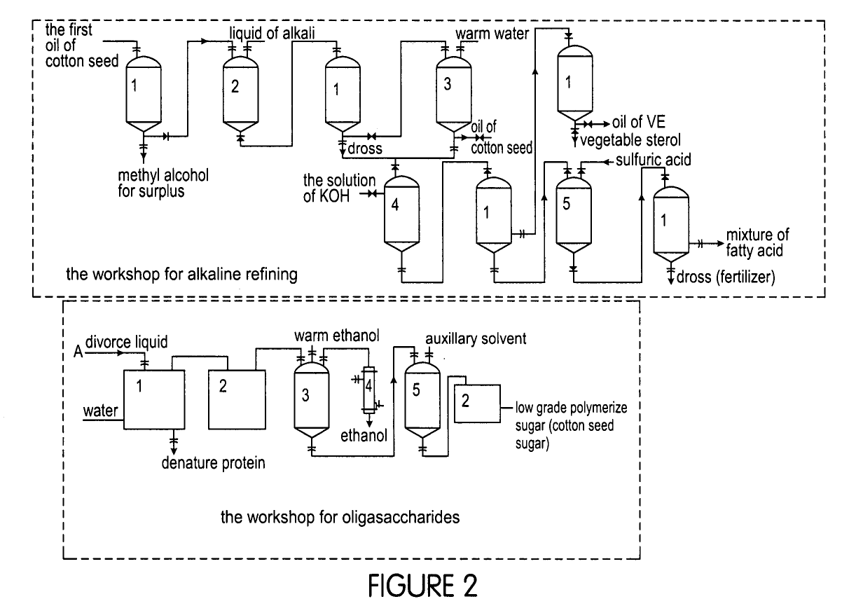

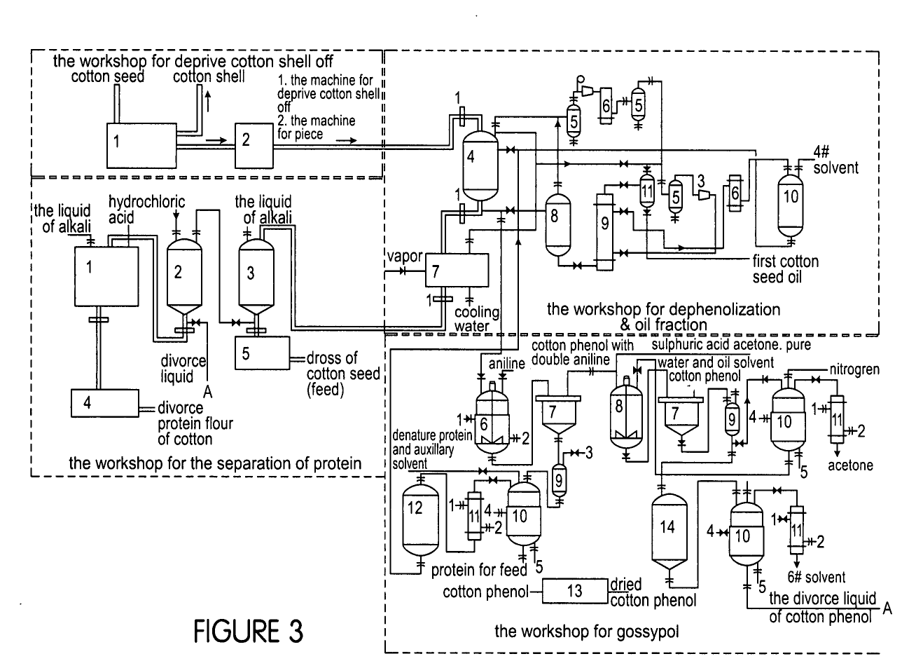

The process to achieve the above-mentioned objectives is described below and shown in FIG. 1. Certain embodiments of the present invention's integrated process are shown in FIGS. 2 and 3.

As an overview of one embodiment of the present invention, FIG. 3 shows a preferred embodiment of the integrated process for oil extraction comprising the husking, oil fraction, protein separation, and gossypol plants (42), (43), (44), and (45) of the present invention. In the husking plant (also known as the workshop for deprive cotton shell off (42), the cottonseed husking machine (1) and the flaking machine (2) are shown. The cottonseed enters the cottonseed husking machine (1), where the cotton shell is separated out and removed. The remainder of the cottonseed travels into the flaking machine (2).

The oil fraction plant (also known as the workshop for dephenolization and oil fraction or the immersion plant) (43) comprises a gas propelled valve (3), a vacuum pump (4), a compressor (5), an oil fraction tank (also known as the immersion tank) (6), a buffer tank (7), a condenser (8), a residue (pulp) dissolving tank (9), a raw oil temporary storage tank (10), an evaporator (11), a solvent tank (12), and a separator (13). The operation and importance of the oil fraction plant (43) is described in more detail herein in connection with the descriptions of FIG. 3.

The protein separation plant (also known as the workshop for separation of protein) (44) consists of a neutralization, disinfecting and antibacterial tank (14), a separator (15), a spray dryer (16) and a dryer (17). The operation and importance of the protein separation plant (44) is described with more specificity herein in connection with the descriptions of FIG. 3.

Referring to the gossypol plants (also known as the workshop for gossypol) (45), the plant comprises of water outlets (18), water inlets (19), a connection to a vacuum pump (20), vapor inlets (21), dihronates (22), a crystallization tank (23), an oil filtration tank (24), a hydrolyzation tank (25), a vacuum buffer (26), an evaporator (27), condensers (28), a methanol temporary storage tank (29), a vacuum dryer (30), and a separator (31). A more detailed description of the importance and operation of the gossypol plants (45) is provided herein in connection with the description of FIG. 3.

In a preferred embodiment of the present invention, cottonseed is directed into the cottonseed husking machine (1) in the husking plant (42). Other suitable oil seeds such as sunflower seed, safflower seed, rape seed, poppy seed, flax seed, and the like can be used.

FIG. 1 shows an overview of a preferred embodiment of one process for the separation of oil, protein, carbohydrates, shell, and toxic components from seeds. The cottonseed shells are removed from the cottonseed husk. The shells undergo dephenolization to produce coloring.

Also shown in FIG. 1, the husk of the cottonseed is compressed into flakes and subjected to dephenolization to produce oil fraction. The oil fraction can be converted to crude oil and then refined oil. Alternatively, the oil fraction can undergo a neutralization process to yield protein waste solution (that can be converted into carbohydrates) and hydrolyzed or separated protein. Alternatively, the flakes can undergo the dephenolization process, be subjected to a chromium-gossypol complex and hydrotypes, to yield chromium-free industrial gossypol. The process outlined in FIG. 1 is illustrated in more detail by way of the descriptions of the other embodiments of the present invention herein.

The first step in a preferred embodiment of the present invention of processing of oil seeds is cleaning the seeds to separate foreign materials from the seeds. Sticks, stems, leaves, and similar trash are usually removed by means of revolving screens or reels. Sand and dirt are also removed by screening. Other equipment such as permanent electromagnets installed on conveyor belts, special “stoners” or pneumatic system are used. The cleaning of oil seeds is preferably carried out before the seeds are placed in storage. Many other suitable cleaning methods will be obvious to those skilled in the art and are encompassed by this invention.

As illustrated in FIG. 3, oil seeds are preferably decorticated before they are separated. The hulls of oil-bearing seeds are low in oil content, usually containing not more than about one (1%) percent oil. If the hulls are not removed from the seeds before the kernel is extracted, they reduce the total yield of oil by absorbing and retaining oil in the residue and, hence, reduce the capacity of the extraction equipment.

Bar huller and disc huller machines (among others) can be used for decortication of medium-sized oil seeds with a flexible seed coat, such as cottonseed, peanuts, and sunflower seed. The rotating member of a bar huller is a cylinder equipped on its outer surface with slightly projecting, longitudinally placed, sharply ground, square-edged knives or “bars”. The seeds are fed between the rotating cylinder and the concave member, and the hulls are split as the seeds are caught between the opposed cutting edges. The disc huller is more or less similar in principle to the bar huller, except that the cutting edges consist of grooves cut radially in the surfaces of two opposed and vertically mounted discs, one of which is stationary and the other rotating. The condition of the seed is somewhat critical. In the case of cottonseed the following separations are commonly carried out: (a) separation of large meat particles from hulls and uncut seed by screening; (b) separation of hulls from uncut seed by air lift; (c) separations of small meat particles from hulls by beating and screening; and (d) separation of hull particles from meats by air.

In one embodiment of the present invention, cottonseeds are invariably delivered to the mills from the gins without removal of the coating of short fibers or linters and, therefore, must be delinted before they are hulled. Delintering machines (known as linters) are similar in principle and appearance to cotton gins, consisting essentially of a revolving assembly of closely spaced circular saws that pick the lint from the seed. The fibers can be removed from the saw teeth by revolving cylindrical brush or by air blast that suspends them in an air stream in which they are conveyed through pipes to collection equipment. It will be apparent to those skilled in the art that other types of linters or delinting processes may be used and are within the scope of the present invention.

After the dehulling of cottonseed, through rigid separation of shells and kernels, cottonseed kernel is compressed into flakes of sizes ranging between 0.28-0.35 millimeters at room temperature using a flaking machine vessel (2) as shown in FIG. 3. This flaking is also represented by step of FIG. 1 in which the cottonseed is compressed into flakes. The compressed flakes will facilitate the extraction process by reducing the distances that solvent and oil must diffuse in and out of the seed during the extraction process. The extraction rate should theoretically be indirectly proportional to the square of the flake thickness; doubling the thickness, for example, should quadruple the time required for reduction of the residual oil to a given level. Reasonably high moisture content is required in oil seeds that are to be formed into thin, coherent flakes. Very dry flakes do not flake well.

Next, these flakes are fed into an agitated leaching (extraction) tank (6) in the immersion plant (43). In this vessel the flakes are agitated and mixed with a mixture of dephenolizers, which contain: (i) an alcohol, such as methanol or ethanol; an acid, such as phosphoric acid, nitric acid, etc.; and enzymes. In the preferred embodiment, the time to leach the flakes and dephenolizers is in a range of between fifteen (15) minutes and eighteen (18) hours. The preferred temperature ranges from 0° C. to 70° C. It will be apparent to those skilled in the art that other temporal and heat ranges may be employed but they would impact the effectiveness and efficiency of the process. Those alternative ranges are included in this invention.

In order to fully extract the gossypol in the cottonseed kernels, especially to convert the gossypol-complex into free gossypol by de-bonding, without denaturing the cotton proteins and to minimize usage of soluble oil in the process of dephenolization, the technology of the preferred embodiment of the present invention includes the use of a dephenolization mixture (see the dephenolization (extraction) step of FIG. 1.) In the preferred embodiment, the mixture consists of an alcohol concentration (methanol or ethanol), acid (nitric acid, hydrochloric acid or phosphoric acid, etc.), and enzymes at concentration ranges respectively of 65-99%, 3-85%, 0.4-65 μg/ml, and a weight ratio of a range of 10-15.0 (alcohol concentration): 0.005-0.05 (acid): 0.00006-0.0009 (enzyme). The weight ratio of the dephenolization mixture to cottonseed kernel in the preferred embodiment is in the range of 3-15:1. These ratios may vary depending upon the types of oil seeds used and the correct ratios for different seeds will be apparent to those skilled in the art.

In the preferred embodiment, the filtrate is transferred into a complexing tank vessel where the compound aniline is added to produce aniline-gossypol complex, through hydrolyzation that takes place in the hydrolyzation tank (25) in the gossypol plant (45). Other compounds such as chromium, if added, will form a chromium-gossypol complex. The formed complex will undergo crystallization in the crystallization tank (23), filtration in the oil filtration tank (24), and later washing, which yields more than eighty (80%) percent of industrial gossypol.

The remaining solution is transferred into the separator (39) in the oligosaccharide plant (also known as the workshop for oligosaccharides) (46). Generally, FIG. 2 shows the alkali refining (also known as the workshop for alkaline refining) and oligosaccharide plants (47) and (46) of the present invention. The alkali refining plant (47) comprises separator/skimming tanks (32), the alkali refining tank (33), the flushing separator (34), the saponification tank (35), and the acid flushing tank (36). The oligosaccharide plant (46) comprises the dehydration filtration apparatus (37), the dessicator (38), the separator (39), the condenser (40), and the crystal separator (41).

In one embodiment of the present invention, dephenolized cottonseed kernel, with the addition of propane and butane, is immersed in the immersion tank (6) in the immersion plant (43) (shown in FIG. 3) to extract out the oil at 5° C. to 45° C. The extracted oil mixture can be recycled to obtain clear innoxious cotton oil, through decompression, aeration, and evaporation in propane and butane solutions. Cottonseed residue (pulp), which oil has been extracted, is transferred into the protein extraction tank vessel.

Alkali (either NaOH or KOH) is added to the cottonseed residue to adjust the pH value to a range of between 9 and 12. The cottonseed residue is dissolved in the alkaline solution for a range of ten to ninety (10-90) minutes; followed by centrifugation for separation (purification). The supernatant is added with acid to adjust the pH value to a range of 3.8 to 5.8 and further centrifuged. The protein precipitation is bleached and sent to the spray-drying tower (16) to obtain separated cotton protein powder. After the centrifugation process and prior to the spraying process, the protein precipitation is then sent for hydrolyzation and addition of proteolytic enzyme compound for enzymolysis. Hydrolyzed protein is obtained. Protein waste (water) solution and waste (water) solution from hydrolyzation of gossypol-complex are transferred into an oligosaccharide evaporating tank (27), evaporated, and filtered to get smaller molecule ethanol and water soluble protein. Saturated limewater is added to the protein waste solution and the mixture is allowed to precipitate. This is followed by filtration of the residual gossypol and removal of salt by electrodialysis. The residual solution of the above-outlined steps is condensed to get paste-like cottonseed sugar.

In order to ensure the cotton protein is stable (i.e., does not denature) and to minimize residual solution, a preferred embodiment of the invention uses a non-CO₂ supercritical extraction method to obtain oil and to flush away residual dephenolizer (dephenolization mixture) in the cottonseed cake (extracted pulp). A supercritical fluid is a material, which can be either liquid or gas, used in a state above the critical temperature and critical pressure where gases and liquids can coexist. The supercritical fluid shows unique properties that are different from those of either gases or liquids under standard conditions. The preferred supercritical fluid has the gaseous property of being able to penetrate anything, or the liquid property of being able to dissolve materials into their components. In a preferred embodiment, such supercritical fluid solution used is a mixture of propane and butane.

Supercritical fluids offer a favorable means to achieve solvating properties that have gas-and liquid-like characteristics without actually changing the chemical structure of the supercritical fluid. By proper control of pressure and temperature, a significant range of physiochemical properties (density, diffusivity, dielectric constants, etc.) without passing through a phase boundary, e.g. changing from gas to liquid form. In a preferred embodiment, the supercritical fluid's preferred working pressure is in the range of 0.6 mpa-1.2 mpa and the temperature ranges from 0° C. to 3° C. The preferred ratio of propane to butane in the supercritical fluid mixture is in the range of 1-6:9-4. The weight ratio of the supercritical fluid mixture to cottonseed according to this invention is preferably in the range of 2-17:1. The weight ratio between propane/butane and cotton kernel is preferably in the range of 0.5-9:1. The preferred extraction time ranges from ten (10) minutes to eight (8) hours. This occurs in the dephenolization step of FIG. 1.

Supercritical extraction provides some distinct advantages over other separation techniques, including: (i) thermally unstable compounds can be separated at low temperatures; (ii) the solvent can be removed easily from the solute by reducing the pressure and/or adjusting the temperature; (iii) thermal energy requirements are lower than for distillation; (iv) surprisingly high selectivity for the solute can be accomplished; and (v) rapid extraction can be achieved due to low viscosity, high diffusivity and good solvating power of the supercritical fluid solvent.

This technology of extracting and refining gossypol from cottonseed is more convenient than conventional technologies at a lower cost. The transferring cost is lowered because of the technology's direct hydrolysis of diphenylamine gossypol under acid and antioxidant conditions. The diphenylamine gossypol's content of acids (sulphuric acid, hydrochloric acid, nitric acid, etc.) concentration is in the range of 8-49%, content of antioxidant is in the range of 50-99%, content of acetone is in the range of 20-95%. Chromium-gossypol complex hydrolyzation additive is formed at the weight ratio in the range of 5-15:1-7:11-45. The chromium-gossypol complex's hydrolyzation additive's weight ratio with diphenylamine is in the range of 11-25:3-16. These steps correspond with the hydrolysis step of FIG. 1. Other industrial seeds can be used and will have varying acid contents.

This invention has overcome the shortcomings of conventional protein factories, which pollute the environment with organic wastewater, and the present invention produces oligosaccharide supplement by evaporation, dephenolization, removal of salt and condensation of the gossypol wastewater and protein wastewater. The evaporation temperature during production is in the range of 70° C. to 200° C. Evaporation time ranges from ten (10) minutes to ninety (90) minutes. The evaporation corresponds to the crude protein step of FIG. 1. In one embodiment, the pH value limewater used to remove phenol is in the range of 8.5-12 and the weight ratio of limewater to waste water is in the range of 0.05-0.7:1.

While particular embodiments of the subject invention have been described, it will be obvious to those skilled in the art that various changes and modifications to the subject invention can be made without departing from the spirit and scope of the invention. The present invention is intended to cover, in the appended claims, all such modifications that are within the scope of this invention.

1. A process for extracting oil, protein, carbohydrates, shell, and minor toxic components from seeds comprising the steps of:
a. dehulling oil seed to separate out the shell and the kernel;
b. compressing said kernel obtained in step (a) into flakes at room temperature;
c. agitating and mixing said flakes obtained in step (b) with a mixture of dephenolizers for a period of time at a specific temperature to obtain a filtrate and dephenolized kernel flakes, which together form a dephenolization mixture;
d. mixing said filtrate obtained in step (c) with a complexing compound to form a gossypol complex;
e. hydrolyzing, crystallizing, filtering, and washing said gossypol complex to yield industrial gossypol;
f. treating said dephenolized kernel flakes obtained in step (c) with liquid propane and butane to yield oil and pulp;
g. dissolving said pulp derived from said oil extraction in an alkali to yield a protein waste solution upon precipitation; and
h. adding saturated limewater to said protein waste solution obtained in (g), followed by precipitation and filtration of residual gossypol, electrolysis, and condensation to yield carbohydrates.

2. The process of claim 1, wherein said oil seed kernel is directly flaked or cold pressed.

3. The process of claim 1, wherein said mixture of dephenolizers comprises an alcohol, a suitable acid, and an enzyme.

4. The process of claim 3, wherein said alcohol is selected from the group consisting of methanol and ethanol.

5. The process of claim 3, wherein said suitable acid is selected from the group consisting of nitric acid, hydrochloric acid, and phosphoric acid.

6. The process of claim 3, wherein in said mixture of dephenolizer, the alcohol concentration is in a range from 65%-99%, the acid concentration is from 3%-85%, and the enzyme concentration is in a range from 0.4-65 μg/ml.

7. The process of claim 3, wherein the weight ratio of alcohol concentration to the acid to the enzyme is in the range of 10-15.0 (alcohol concentration): 0.005-0.05 (acid): 0.00006-0.0009 (enzyme).

8. The process of claim 3, wherein the weight ranges of said alcohol concentration to said acid to said enzyme is in the ranges of 10-15:0.005-0.05:0.00006-0.009.

9. The process of claim 4, wherein the weight ranges of said alcohol concentration to said acid to said enzyme is in the ranges of 10-15:0.005-0.05:0.00006-0.009.

10. The process of claim 5, wherein the weight ranges of said alcohol concentration to said acid to said enzyme is in the ranges of 10-15:0.005-0.05:0.00006-0.009.

11. The process of claim 1, wherein the weight ratio of said dephenolization mixture to said oil seed kernel is in the range of 3-5:1

12. The process of claim 1, wherein the dephenolization time is in the range of fifteen (15) minutes to eighteen (18) hours

13. The process of claim 1, wherein the temperature for the dephenolozation of step c is in the range of 0° C.-70° C.

14. The process of claim 1, wherein said complexing compound is selected from the group consisting of aniline and chromium.

15. The process of claim 1, wherein the weight ratio of liquid propane and butane to oil seed kernel is in the range of 0.5-9:1

16. The process of claim 1, wherein the elution time for step f is in the range of ten (10) minutes to eight (8) hours.

17. The process of claim 1, wherein said process further comprises the step of separating gossypol from seed, wherein the seed oil-complex hydrolyzation additive comprises an acid selected from the group consisting of sulphuric acid and nitric acid, an antioxidant, and acetone with weight ratio in the range of 5-15:1-7:11-45, respectively.

18. The process of claim 17, wherein the weight ratio of said hydrolyzation additive to seed oil-complex is in the range of 11-25:3-16.

19. The process of claim 1, wherein the process of step e further comprises the step of forming aniline-gossypol complex that is subjected to hydrolyzation, crystallization, filtration, and washing to yield an industrial gossypol.

20. The process of claim 1, wherein the process further comprises the step of adding propane and butane to dephenolized kernel for extraction of oil.

21. The process of claim 1, wherein the process further comprises the steps of adding alkaline solution to dissolve the pulp derived from oil extraction, centrifugation, protein precipitation, bleaching and spray drying to yield protein.

22. The process of claim 21, wherein after centrifugation and before spray drying, proteolytic enzyme is added for hydrolyzation to yield hydrolyzed protein.

23. The process of claim 1, wherein the process further comprises the steps of:
a. treating protein waste solution and waste solution from hydrolyzation of gossypol complex by evaporation and filtration;
b. adding of saturated limewater;
c. filtration and electrolysis of residual gossypol; and
d. condensation of residual solution to yield carbohydrates.

24. The process of claim 1, wherein said protein waste solution and waste water from hydrolyzation are treated to recover useful components such as ethanol and water-soluble protein.

25. The process of claim 1, wherein the seed is selected from the group consisting of cottonseed, rubber seed, sunflower seed, safflower seed, peanut, flax seed, hemp seed, rape seed, poppy seed, and any other suitable seed.

26. The process of claim 1, further comprising performing a supercritical extraction to obtain oil and to flush away the residual dephenolizer.

27. A seed oil produced according to the process of claim 1.

28. An apparatus for producing the seed oil comprising:
a. an oil seed dehuller to separate out the shell and the kernel;
b. a flaking machine to compress said kernel obtained in step (a) into flakes at room temperature;
c. an agitated leaching tank in which to mix said flakes obtained in step (b) with a mixture of dephenolizers for a period of time at a specific temperature to obtain a filtrate and to dephenolized kernel flakes, which together form a dephenolization mixture;
d. a complexing tank vessel in which said filtrate obtained in step (c) is mixed with a complexing compound to form a gossypol complex;
e. a hydrolyzation tank in which to hydrolyze, crystallize, filter, and wash said gossypol complex to yield industrial gossypol;
f. an immersion tank in which to treat said dephenolized kernel flakes obtained in step (c) with liquid propane and butane to yield oil and pulp;
g. a protein extraction tank in which to dissolve said pulp derived from said oil extraction in an alkali to yield a protein waste solution upon precipitation; and
h. an apparatus in which to add saturated limewater to said protein waste solution obtained in (g), followed by precipitation and filtration of residual gossypol, electrolysis, and condensation to yield carbohydrates.

29. The apparatus of claim 28, wherein said oil seed kernel is directly flaked or cold pressed.

30. The apparatus of claim 28, wherein said mixture of dephenolizers comprises an alcohol, a suitable acid, and an enzyme.

31. The apparatus of claim 30, wherein said alcohol is selected from the group consisting of methanol and ethanol.

32. The apparatus of claim 30, wherein said suitable acid is selected from the group consisting of nitric acid, hydrochloric acid, and phosphoric acid.

33. The apparatus of claim 30, wherein in said mixture of dephenolizer, the alcohol concentration is in a range from 65%-99%, the acid concentration is from 3%-85%, and the enzyme concentration is in a range from 0.4-65 μg/ml.

34. The apparatus of claim 30, wherein the weight ratio of alcohol concentration to the acid to the enzyme is in the range of 10-15.0 (alcohol concentration):0.005-0.05 (acid):0.00006-0.0009 (enzyme).

35. The apparatus of claim 30, wherein the weight ranges of said alcohol concentration to said acid to said enzyme is in the ranges of 10-15:0.005-0.05:0.00006-0.009.

36. The apparatus of claim 31, wherein the weight ranges of said alcohol concentration to said acid to said enzyme is in the ranges of 10-15:0.005-0.05:0.00006-0.009.

37. The apparatus of claim 32, wherein the weight ranges of said alcohol concentration to said acid to said enzyme is in the ranges of 10-15:0.005-0.05:0.00006-0.009.

38. The apparatus of claim 28, wherein the ratio of said dephenolization mixture to said oil seed kernel is in the range of 3-5:1

39. The apparatus of claim 28, wherein the dephenolization time is in the range of fifteen (15) minutes to eighteen (18) hours

40. The apparatus of claim 28, wherein the temperature for the dephenolization of step c is in the range of 0° C.-70° C.

41. The apparatus of claim 28, wherein said complexing compound is selected from the group consisting of aniline and chromium.

42. The apparatus of claim 28, wherein the weight ratio of liquid propane and butane to oil seed kernel is in the range of 0.5-9:1

43. The apparatus of claim 28, wherein the elution time for step f is in the range of ten (10) minutes to eight (8) hours.

44. The apparatus of claim 28, in which step e further comprises:
the step of separating gossypol from seed, wherein the seed oil-complex hydrolyzation additive comprises an acid selected from the group consisting of sulphuric acid and nitric acid, an antioxidant, and acetone with weight ratio in the range of 5-15:1-7:11-45, respectively.

45. The apparatus of claim 44, wherein the weight ratio of said hydrolyzation additive to seed oil-complex is in the range of 11-25:3-16.

46. The apparatus of claim 28, wherein the apparatus further comprises:
the step of forming aniline-gossypol complex that is subjected to hydrolyzation, crystallization, filtration, and washing to yield an industrial gossypol.

47. The apparatus of claim 28, further comprising adding propane and butane to dephenolized kernel in said agitated leaching tank for extraction of oil.

48. The apparatus of claim 28, further comprising the steps of adding alkaline solution to dissolve the pulp derived from oil extraction, centrifugation, protein precipitation, bleaching and spray drying to yield protein.

49. The apparatus of claim 48, wherein after centrifugation and before spray drying, proteolytic enzyme is added for hydrolyzation to yield hydrolyzed protein.

50. The apparatus of claim 28, wherein the apparatus further comprises:
a. an apparatus for treating protein waste solution and waste solution from hydrolyzation of gossypol complex by evaporation and filtration;
b. an apparatus in which to add saturated limewater;
c. a filter for the filtration and electrolysis of residual gossypol; and
d. a condenser of residual solution to yield carbohydrates.

51. The apparatus of claim 28, wherein said protein waste solution and waste water from hydrolyzation are treated to recover useful components such as ethanol and water-soluble protein.

52. The apparatus of claim 28, wherein the seed is selected from the group consisting of cottonseed, rubber seed, sunflower seed, safflower seed, peanut, flax seed, hemp seed, rape seed, poppy seed, and any other suitable seed.

53. The apparatus of claim 28, further comprising an apparatus in which to perform a supercritical extraction to obtain oil and to flush away the residual dephenolizer.
